(19) United States
(12) Patent Application Publication
(10) Pub. No.: US 2010/0062828 A1
(43) Pub. Date: Mar. 11, 2010

(54) Gaming machine with bonus game

(75) Inventors: Katsumi Takahashi, Las Vegas, NV (US); Toshiyuki Yoshimura, Las Vegas, NV (US)

Correspondence Address: MASUVALLEY & PARTNERS, 8765 AERO DRIVE, SUITE 312, SAN DIEGO, CA, 92123, US

(73) Assignee: Konami Gaming, Incorporated, Las Vegas, NV (US)

(21) Appl. No.: 12/283,064

(22) Filed: Sep. 8, 2008

(51) Int. Cl. A63F 9/24; A63F 13/00

(52) U.S. Cl. 463/20

(57) ABSTRACT

The present invention is a gaming machine including a wager device for receiving a wager, an initiator for performing a primary game in response to the wager, a processor for implementing a secondary game independently of the primary game, a reel display for indicating outcome of the primary game and winning outcome of the secondary game on a reel and a payout device for awarding a reward according to the winning outcome of secondary game, wherein the initiator works independently of the processor.

### TECHNICAL FIELD

The present invention relates to a gaming machine which can be independently executed a plurality of kinds of games. Concretely, a gaming machine related to the present invention can execute three kinds of games which cast lots in winning-a-prize determination, and each game may be completely executed independently. And a result of each game is displayed using the same display mounted in gaming machine.

### BACKGROUND OF THE INVENTION

A gaming machine usually has a primary game and a bonus game (wheel game etc.). Formerly, the machine in which the determination of whether the bonus game starts is determined depend on a lottery result of the primary game has been a main stream. Therefore, in a conventional gaming machine, the bonus game is a game always executed depending on a primary game, and the start timing had restriction. The game itself became monotonous and an appearance of the gaming machine. So the gaming machine having more intricately advanced and various games, has been desired. Further, it has been an indispensable requirement for gaming machines to have a game, which is easily recognized by a player although the game is rich in variety.

### SUMMARY OF THE INVENTION

One aspect of the present invention may be a gaming machine including a wager device for receiving a wager, an initiator for performing a primary game in response to the wager, a processor for implementing a secondary game independently of the primary game, a reel display for indicating outcome of the primary game and winning outcome of the secondary game on a reel; and a payout device for awarding a reward according to the winning outcome of the secondary game, wherein the initiator works independently of the processor.

Since secondary game will be executed completely independent from a primary game when configuring the gaming machine according to the above-mentioned structure, start time of a secondary game is not dependent on the game contents of a primary game. From this, a bonus game produced from the secondary game can be started at random at any time without related to a result of the primary game. Accordingly, timing of the secondary game produced in the primary game can be made into more rich in variety. While more intricately advanced and various games can be developed, since results of both primary game and secondary game are displayed using the same display machine, it is easy for a player to recognize a result of a game and to make a game which can be easily enjoyed.

The reel display indicates the winning outcome of the secondary game between the outcome of the primary game and an initiation of the primary game.

By having the above-mentioned structure, a result of the primary game, which a player is performing, is displayed on the display first. Then a result of the secondary game is displayed after once completing the primary game. Therefore, the player can easily grasped whether a result currently displayed on a display is a result of primary game or a result of secondary game for the player. By doing this way, a game by which a player is not stumped and a game, which is easy to be recognized, can be made.

The processor may further implement a tertiary game independently of the primary game and the reel display may indicate winning outcome of the tertiary game.

By allowing the gaming machine to execute a tertiary game, the gaming machine can execute more intricately advanced and various games now.

The reward of the secondary game may be bigger than a reward of the tertiary game.

By making the refund relevant to the secondary game larger than the refund relevant to the tertiary game, when displaying a winning-a-prize result on a display, an expectation of a player of wanting refund of the secondary game to come out can be swollen regardless of the winning prize of which game is displayed.

The reel display may indicate the outcome of a primary game in the first step, indicate the winning outcome of a tertiary game in the second step and indicate the winning outcome of the secondary game in the third step, and the first step, the second step and the third step may be continued.

When configuring above-mentioned structure and displaying a result of the tertiary game on a display once, there may be a case where a player may be disappointed about not being a result of the secondary game. Even in such a case, since the winning a prize of the secondary game, which is about to be given up once, can be received by a result of the secondary game being displayed further after that, the player can be pleased with it.

The processor may implement a special game after the reel display indicates the winning outcome of the secondary game. The special game may be a roulette game or a wheel game.

Another aspect of the present invention may be a gaming machine including, an initiator, which starts a primary game in response to receiving a wager, a processor, which commences a secondary game independently of the primary game and decides when outcome of the secondary game is winning outcome, a reel display, which represents a trigger information on a reel when the outcome of the secondary game is winning outcome, and a controller, which, a) communicates with the processor and the reel display, b) receives signals from the processor, and c) transmits signals to the reel display, wherein the initiator works independently of the processor and the controller.

Since secondary game will be executed completely independently of the primary game, when the gaming machine is configured according to the above-mentioned structure, the start time of the secondary game is not dependent on the contents of a game of the primary game. From this, a bonus game produced from the secondary game can be started at random at anytime regardless of the result of primary game. Accordingly, timing of the secondary game produced in the primary game can be made into more rich in variety. While more intricately advanced and various games can be developed, since results of both primary game and secondary game are displayed using the same display machine, it is easy for a player to recognize a result of a game and to make a game which can be easily enjoyed.

The processor further commences a tertiary game independently of the primary game and the reel display represents winning outcome of the tertiary game.

By allowing the gaming machine to execute a tertiary game, the gaming machine can execute more intricately advanced and various games now.

The reel is configured by a plurality of cells forming columns, and the reel display indicates a plurality of symbols in the cells, and the reel display indicates symbols in columns other than a predetermined column in a first step, and the reel display indicates symbols in the predetermined column in a second step.

The predetermined column may be at the far right on the reel. The trigger information and the winning outcome of the tertiary game may have the same shape of a symbol stopping at the column at the far right on the reel and these symbols may have a different color with each other. The processor may commence a special game after the reel display represents the trigger information. The special game may be a roulette game or a wheel game. The special game may include a wheel representing a plurality of numbers and a wheel representing a plurality of magnification ratios.

Another aspect of the present invention may be a gaming system including a host computer and a plurality of gaming machines connected to the host computer, each of the gaming machines including, an initiator, which commences a primary game in response to receiving a wager, a processor, which implements a secondary game independently of the primary game, a reel display, which represents outcome of the primary game and winning outcome of the secondary game on a reel, and a controller, which a) communicates with the processor and the reel display b) receives signals from the processor and c)transmits signals to the reel display, wherein the initiator works independently of the processor and the controller.

Since the secondary game will be executed completely independently of the primary game, when the gaming machine is configured according to the above-mentioned structure, the start time of the secondary game is not dependent on the contents of a game of the primary game. From this, a bonus game produced from the secondary game can be started at random at anytime regardless of the result of primary game. Accordingly, timing of the secondary game produced in the primary game can be made into more rich in variety. While more intricately advanced and various games can be developed, since results of both primary game and secondary game are displayed using the same display machine, it is easy for a player to recognize a result of a game and to make a game which can be easily enjoyed.

The processor further may implement a tertiary game independently of the primary game and the reel display may represent winning outcome of the tertiary game.

By allowing the gaming machine to execute a tertiary game, the gaming machine can execute more intricately advanced and various games now.

The reel display represents the winning outcome of the secondary game between the outcome of a primary game and an initiation of the primary game.

By having the above-mentioned structure, once the gaming machine displays a result of primary game which a player is performing on a display first and completes primary game, a the result of the secondary game is displayed. Therefore, the player can easily grasped whether a result currently displayed on a display is a result of primary game or a result of secondary game for the player. By doing this way, a game by which a player is not stumped and a game, which is easy to be recognized, can be made.

A reward of the secondary game may be bigger than a reward of the tertiary game.

By making the refund relevant to the secondary game larger than the refund relevant to the tertiary game, when displaying a winning-a-prize result on a display, an expectation of a player of wanting refund of secondary game to come out can be swollen regardless of the winning prize of which game is displayed.

The processor may implement a special game after the reel display may represent the winning outcome of the secondary game. The special game may be a roulette game or a wheel game. The special game may include a wheel representing a plurality of numbers and a wheel representing a plurality of magnification ratios.

### BRIEF DESCRIPTION OF THE DRAWINGS

FIG. 1 is a perspective view illustrating an example of a gaming machine of the present invention.

FIG. 2 is a drawing illustrating an example (pattern 1) of the contents of a game which gaming machine related to the present invention executes.

FIG. 3 is a drawing illustrating an example (pattern 2) of the contents of a game which gaming machine related to the present invention executes.

FIG. 4 is a drawing illustrating an example (pattern 3) of the contents of a game which gaming machine related to the present invention executes.

FIG. 5 is a drawing illustrating an example (pattern 4) of the contents of a game which gaming machine related to the present invention executes.

FIG. 6 is a drawing illustrating an example (pattern 5) of the contents of a game which gaming machine related to the present invention executes.

FIG. 7 is a drawing illustrating an example (pattern 6) of the contents of a game which gaming machine related to the present invention executes.

FIG. 8 is a drawing illustrating an example of a game to be executed by a gaming machine related to the present invention.

FIG. 9 is a drawing illustrating the state where a game status illustrated in FIG. 8 has advanced. A display of the gaming machine is illustrated in FIG. 9.

FIG. 10 is a drawing illustrating the state where a game status illustrated in FIG. 9 has advanced.

FIG. 11 is a drawing illustrating the state where a game status illustrated in FIG. 10 has advanced.

FIG. 12 is a drawing illustrating the state where a game status illustrated in FIG. 11 has advanced.

FIG. 13 is a drawing illustrating the state where a game status illustrated in FIG. 12 has advanced.

FIG. 14 is a drawing illustrating the state where a game status illustrated in FIG. 13 has advanced.

FIG. 15 is a drawing illustrating the state where a game status illustrated in FIG. 14 has advanced.

FIG. 16 is a flow chart, which illustrates an operation which is executed by a game machine related to a present invention.

### DETAILED DESCRIPTION OF INVENTION

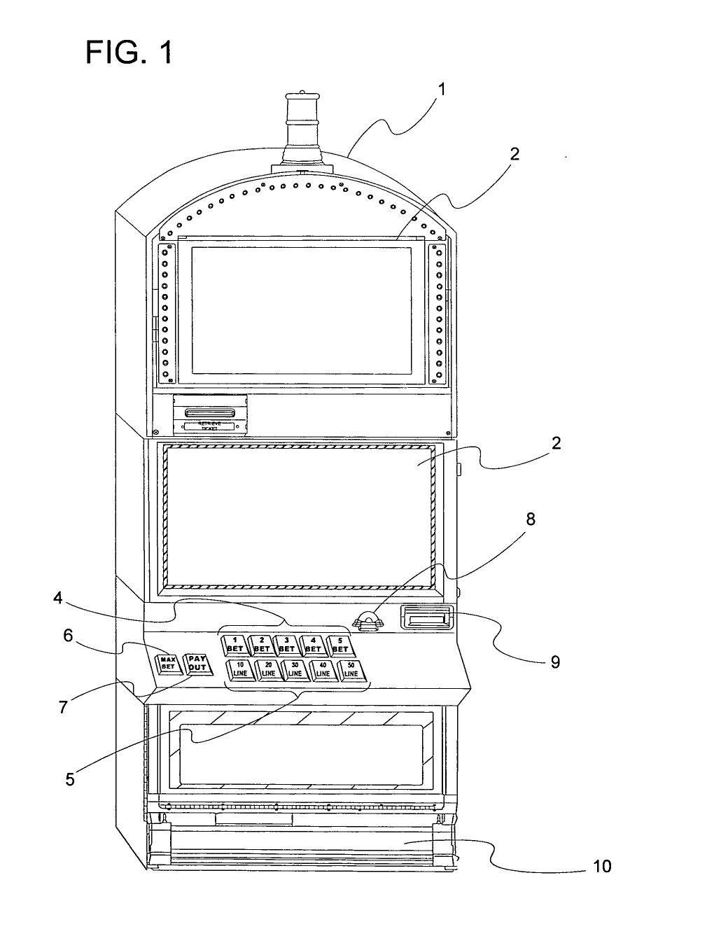

FIG. 1 is a perspective view illustrating an example of a gaming machine of the present invention. As illustrated in FIG. 1, a gaming machine 1 is provided with two displays 2. Immediately under the display 2, such as, a BET switch 4, a selection switch 5, a MAXBET switch 6, a PAYOUT switch 7, a coin slot 8, and a bill acceptor 9, are provided. The BET switch 4 has five switches from 1BET to 5BET. The selection switch 5 has five switches from 1 select to 5 select. A coin tray mouth 10 is provided in the lower part of the gaming machine 1.

The display 2 displays an indication necessary for a player to play games. For example, an indication for performing a primary game or a secondary game is displayed on the display 2. Cards used by a card game, roulette used in a roulette game, coin and a reel used in a reel game, a feature, etc. are displayed on the display 2, for example. An indication for a player to choose a kind of a progressive game or bonus game, and an indication for a player to choose a feature are also displayed.

A progressive screen etc., which displays the amount of money, which a player can receive, may be displayed on the display 2. A representation according to a progress status of the game, a credit, which a player feeds into a gaming machine, and play history etc. of a player may be displayed on the display 2.

A BET switch 4 is a switch for betting and inputting a bet money against a game. A player can bet from 1BET to 5BET using the BET switch 4, and can input bet money into the game of one time. A selection switch 5 is a switch for, for example, selecting a line on a reel and a card, which a player wants to throw away, etc. The number of BET switch 4 and selection switches 5 may not be limited to five, but may be any number. The gaming machine 1 may have a switch for casting 10BET, for example, and may have a switch of 10 select.

A MAXBET switch 6 is a switch for inputting the maximum bet that a player can spend against 1 time of a game. A PAYOUT switch 7 is a switch for repaying to a player the amount of money, which has been credited onto the gaming machine. A coin slot 8 is a hole for a player to perform the credit of the coin to the gaming machine. A bill acceptor 9 is a hole used in order to feed a bill or a cash card into the gaming machine, or in order to repay the amount of money, which has been credited. The coin tray mouth is a tray in order to repay to a player the amount of money by which has been credited to the gaming machine.

A gaming machine related to the present invention is not limited above, but it may have various functions otherwise, and the above-mentioned function may be omitted. For example, when a player rushes into the secondary game, the gaming machine may have a lighting apparatus for making a gaming machine to turn on the lighting apparatus using a color or more colors. When a player rushes into a secondary game, the gaming machine may have an apparatus for outputting music or an apparatus, which vibrates the whole gaming machine. The gaming machine 1 may have three or more displays. The gaming machine 1 may have a switch for choosing the BET, which a player applied in the last game again.

A reel, roulette, etc. which are used in the game do not need to be displayed on a display. A stepper (mechanical reel), mechanical roulette, etc. may be mounted in the gaming machine 1. A display etc., which is commonly used by a plurality of gaming machines, may exist.

Gaming machine related to the present invention can execute a plurality of kinds of game, for example, can execute the primary game, the secondary game and the tertiary game. Usually, these games are games which cast lots in winning-a-prize determination by the gaming machine. For example, primary game is a game which determines whether a player won a prize within the gaming machine, and the result is told to a player using a reel unit with which the gaming machine is equipped. The prizes which are given to a player by the primary game winning may be cash, a credit and or a ticket. Also by the secondary game and the tertiary game, a lottery of winning-a-prize determination is performed inside the gaming machine, respectively, and the result will be notified to the player. However, in the secondary game or the tertiary game, without being notified to a player, particularly in cases where a result of a lottery is not winning a prize, the usual games (a reel game, a card game, a roulette game, etc.) continue, and may be executed. A lottery of winning-a-prize determination may not be performed inside gaming machine, but it may be performed by an apparatus, a system, etc. which exist outside the machine.

One of features of the present invention is a unit for executing a primary game, for example, (it is hereafter called a primary execution unit, initiator, etc.,) may be arranged to operate completely independent of the unit for executing the secondary game and the tertiary game (it is hereafter called a secondary execution unit, processor, etc.,). That is, the contents and the result of the primary game affect neither the contents of the secondary game or the tertiary game, nor the result thereof. For example, a game resulting from the secondary game or the tertiary game is not necessarily started for reasons of winning a prize in the primary game. A unit which executes the secondary game and the tertiary game may be a separate unit, respectively, and may be the same unit. The secondary game and the tertiary game may be independently executed, respectively, and they may be executed so that they may influence each other.

On the other hand, another feature of the present invention is to use a reel, which is used in order to display a result of the primary game, for example, in order to display a winning-a-prize result of the secondary game or the tertiary game to a player. That is, a lottery result of the primary game, the secondary game, and the tertiary game may be presented to a player using a reel with which gaming machine is equipped. However, although each game result is presented on the same reel in this way, the primary game, the secondary game and the tertiary game may be the games which are completely independent.

Although not limited in particular, with regard to the game, which is executed by a gaming machine related to the present invention, for example, a reel game is performed, a primary game is performed inside machine and the result is displayed on a reel. And a secondary game or a tertiary game is executed inside machine on a predetermined condition (random is included), and in the case where the result is winning a prize, it is displayed on the reel. And for example, a wheel game originated in winning a prize of the secondary game is executed. At last, the player may obtain profits by refund based on the primary winning a prize repay and the secondary winning a prize repay. Any kind of cause for the secondary game or the tertiary game to be executed will be acceptable and it may be offered by random lottery by a predetermined apparatus. With regard to this cause, it may be a time when number of rotations of a reel reaches a predetermined number of times, in case where a predetermined time has lapsed, when a player performs predetermined operations, the amount of BET reaches the predetermined amount, the amount of refund exceeds a fixed amount and a predetermined number of players has played, for example. It may be any kind of things. The secondary game or the tertiary game may be performed while primary game is going on, and it may be performed before and after the primary game (for example, reel game etc.).

The contents of the game, which is executed by a gaming machine related to the present invention, will be described hereafter in detail. In the game related to the present invention, a primary game, a secondary game and a tertiary game exist, and a lottery of winning-a-prize determination is usually performed in each game. In the primary game, a reel game is executed on the display of the gaming machine parallel to this lottery game. And a lottery result of the primary game is displayed on the reel display irrespective of whether it is winning a prize. On the other hand, the lottery result of the secondary game and the tertiary game is limited in cases where it is winning a prize, and it is displayed on the reel display.

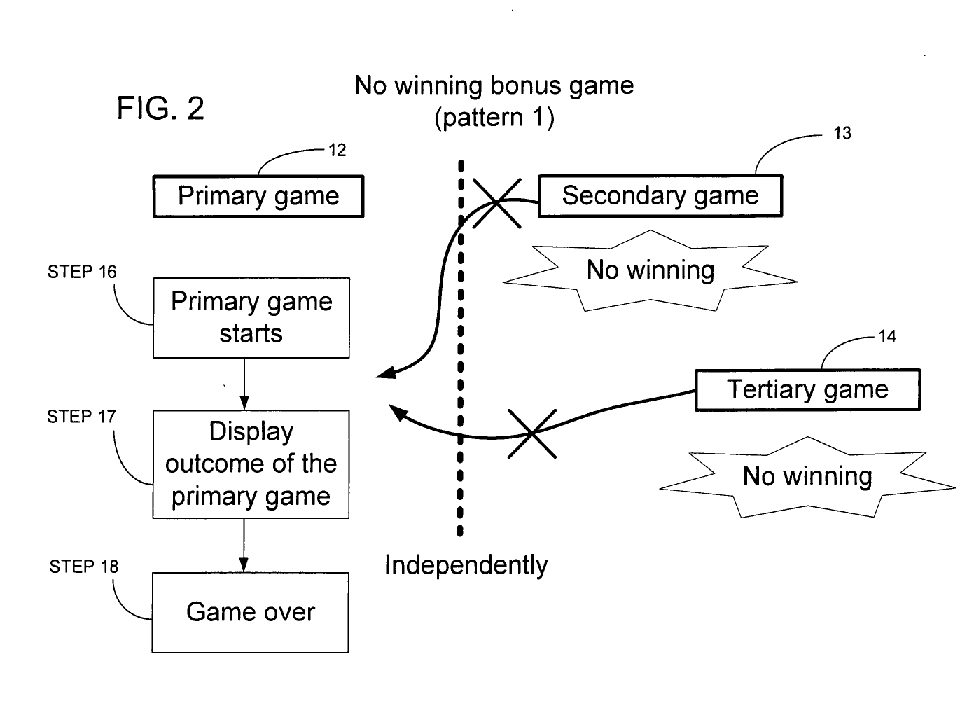

FIG. 2 is a drawing illustrating an example (pattern 1) of the contents of a game which is executed by a gaming machine related to the present invention. Pattern 1 illustrates the case where the lottery results of both games are not winning a prize, although the lottery of winning-a-prize determinations have been performed in a secondary game 13 and a tertiary game 14. In this case, the results of not winning a prize by the secondary game 13 and the tertiary game 14 are not displayed on the reel display. Therefore, on the display, a reel game is executed and only a result of primary game 12 is displayed. With regard to the flow of the games on the display in this case, a primary game starts (STEP 16), a result of primary game is displayed (STEP 17) and a game is ended (STEP 18).

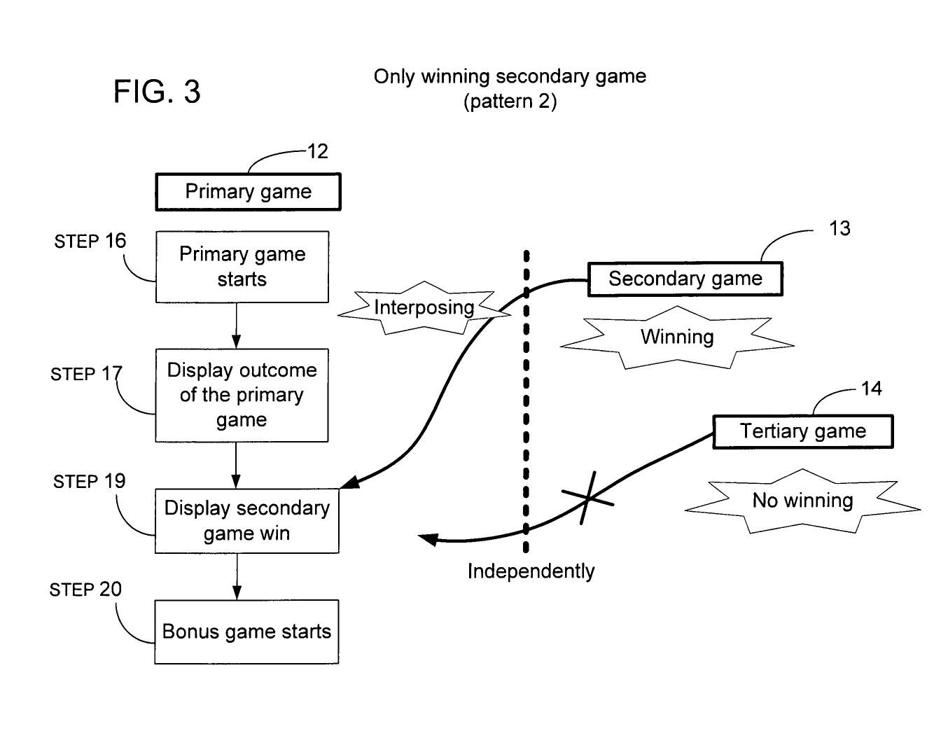

FIG. 3 is a drawing illustrating an example (pattern 2) of the contents of the game which is executed by gaming machine related to the present invention. Pattern 2 illustrates a case where, although a lottery of winning-a-prize determination was performed in the secondary game 13 and the tertiary game 14, a player won a prize in the secondary game, but did not win in the tertiary game. In this case, the result of winning a prize of the secondary game is displayed on the reel display, and the result of not winning a prize of the tertiary game is not displayed on the reel display.

In this case, with regard to the flow of the game on the display, after the primary game starts (STEP 16) and the result of the primary game is displayed (STEP 17), the result of winning a prize of the secondary game is displayed (STEP 19), and a bonus game starts (STEP 20). And the whole game is completed after the Bonus game is completed. After displaying the result of winning a prize of the secondary game, the result of the primary game may be displayed.

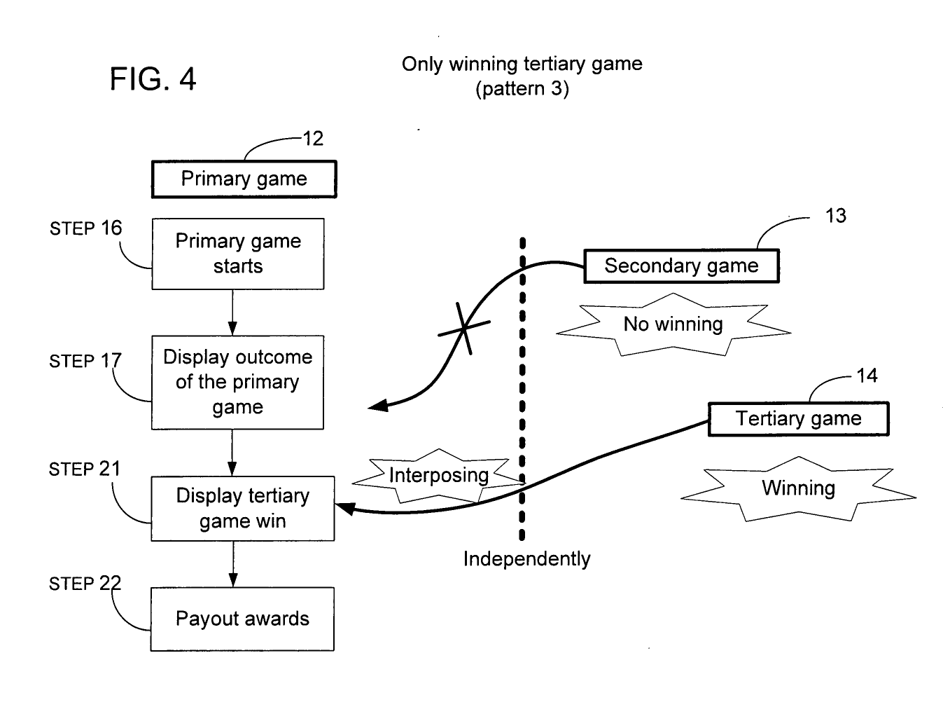

FIG. 4 is a drawing illustrating an example (pattern 3) of the contents of a game which is executed by a gaming machine related to the present invention. Pattern 3 illustrates a case where, although a lottery of winning-a-prize determination was performed in the secondary game 13 and the tertiary game 14, a player won a prize in the tertiary game, but did not win in the secondary game. In this case, a result of winning a prize of the tertiary game is displayed on the reel display, and the result of not winning a prize of the secondary game is not displayed on the reel display. In this case, with regard to the flow of a game on a display, after the primary game starts (STEP 16) and the result of the primary game is displayed (STEP 17), the result of winning a prize of the tertiary game is displayed (STEP 21), and refund is made against the player (STEP 22). And the whole game is completed. After displaying the result of winning a prize of the tertiary game, the result of the primary game may be displayed.

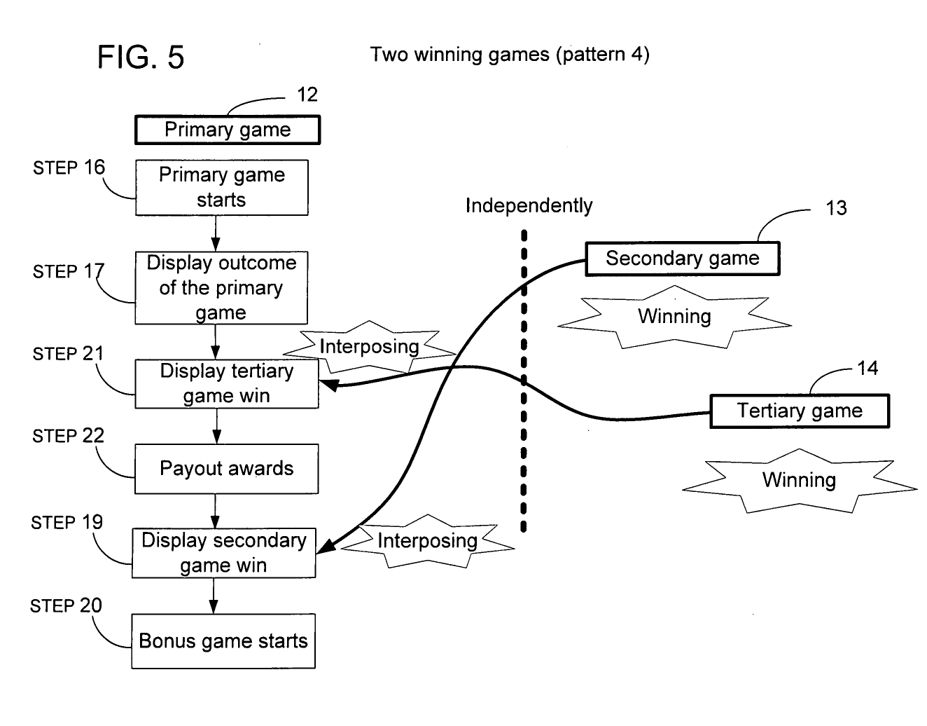

FIG. 5 is a drawing illustrating an example (pattern 4) of the contents of a game which is executed by gaming machine related to the present invention. Pattern 4 illustrates a case where lottery of winning-a-prize determination is performed in the secondary game 13 and the tertiary game 14, and a prize is won in both games. In this case, the results of winning a prize of the secondary game and the tertiary game are displayed on the reel display. In this case, with regard to the flow of the game on a display, after the primary game starts (STEP 16) and the result of the primary game is displayed (STEP 17), the result of winning a prize of the tertiary game is displayed (STEP 21), and refund is made against the player (STEP 22). Then, the result of the winning a prize of the secondary game is displayed (STEP 19), and Bonus game starts (STEP 20). And the whole game is completed after Bonus game is completed. Any kind of showing order of each game result of the primary game, the secondary game and the tertiary game may be acceptable. For example, after displaying the winning-a-prize result of the secondary game, the winning-a-prize result of the tertiary game may be displayed. After displaying the winning-a-prize result of the secondary game and the tertiary game, the result of the primary game may be displayed.

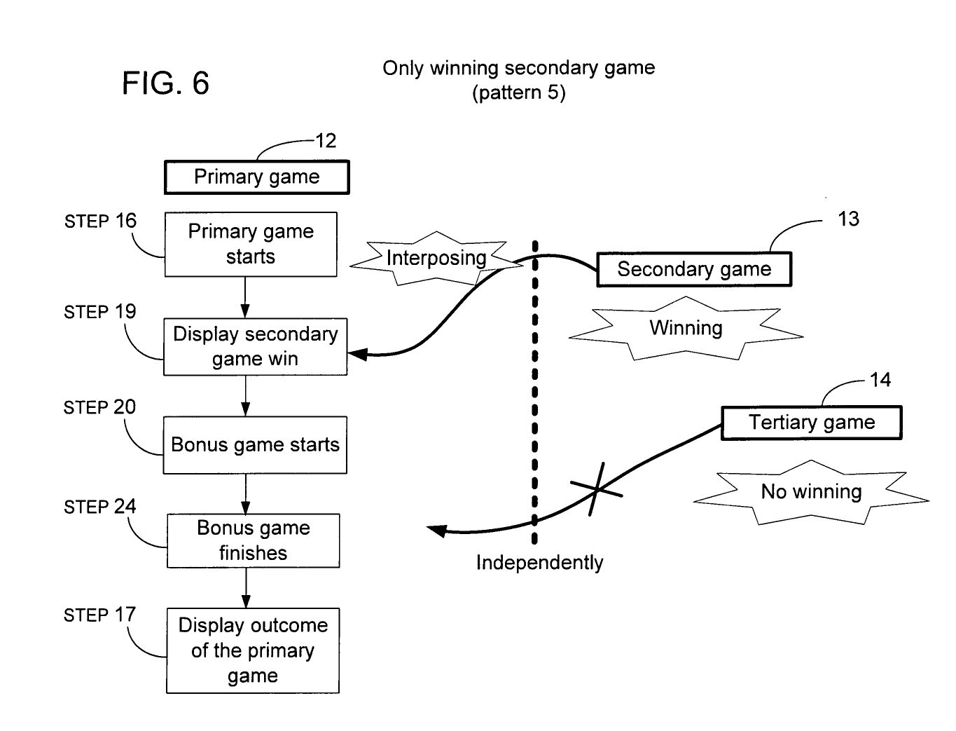

FIG. 6 is a drawing illustrating an example (pattern 5) of the contents of a game which is executed by a gaming machine related to the present invention. Pattern 5 shows a case where a prize was not won in the tertiary game and a prize was not won in secondary game, although a lottery of winning-a-prize determination were performed in the secondary game 13 and the tertiary game 14. In this case, as a flow of the game on the display, the primary game starts (STEP 16), the result of winning a prize of the secondary game is displayed (STEP 19), and Bonus game starts (STEP 20). And after Bonus game is completed (STEP 24), a result of the primary game may be displayed (STEP 17).

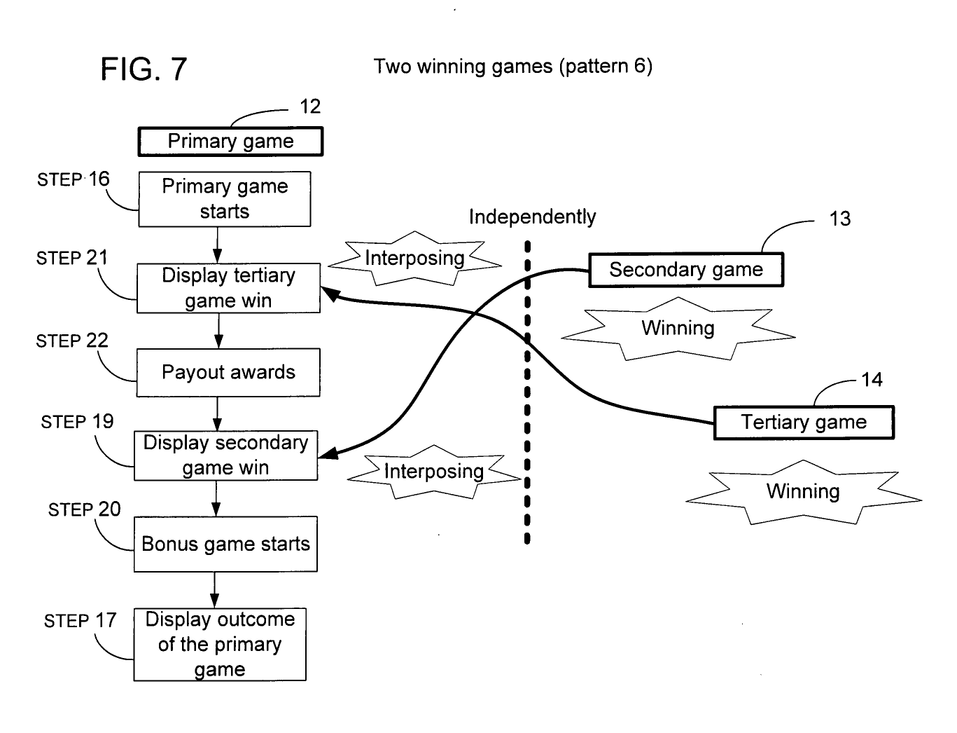

FIG. 7 is a drawing illustrating an example (pattern 6) of the contents of a game which is executed by a gaming machine related to the present invention. Pattern 6 shows a case where a lottery of winning-a-prize determinations is performed in the secondary game 13 and the tertiary game 14, and a prize is won in both games. In this case, with regard to the flow of the game on the display, the primary game starts (STEP 16), and after a winning-a-prize result of the tertiary game is displayed (STEP 21) and refund is made against the player (STEP 22), a result of winning a prize of secondary game may be displayed (STEP 19). And after Bonus game is performed after that (STEP 20), a result of the primary game may be displayed (STEP 17).

Although the flow of a game which is executed by a gaming machine related to the present invention has been explained concretely, the present invention is not limited to these. For example, the lottery of winning-a-prize determination does not need to be performed in both secondary game and tertiary game. The lottery of winning a prize determination may be performed only in the secondary game and does not need to be performed in the tertiary game. It is not necessary to finish the whole game after finishing the Bonus game or after performing a paying back operation, but the primary game may be carried out after that. The secondary game or the tertiary game is carried out one time but may be performed two or more times, respectively parallel to the primary game.

The kind of game, which is executed after the secondary game winning a prize does not need to be Bonus game. The game caused with the winning outcome of the secondary game may be a special game. The special game may include the bonus game, a roulette game and a wheel game. And it is not necessary to be refund after tertiary game winning a prize. Instead of Bonus game or refund, whatever, such as issue of a gift certificate, a coupon and a meal ticket may be used. The kind of Bonus game may be anything, for example, may be a wheel game, a jack pot game, a game that chooses one from a plurality of subjects, etc.

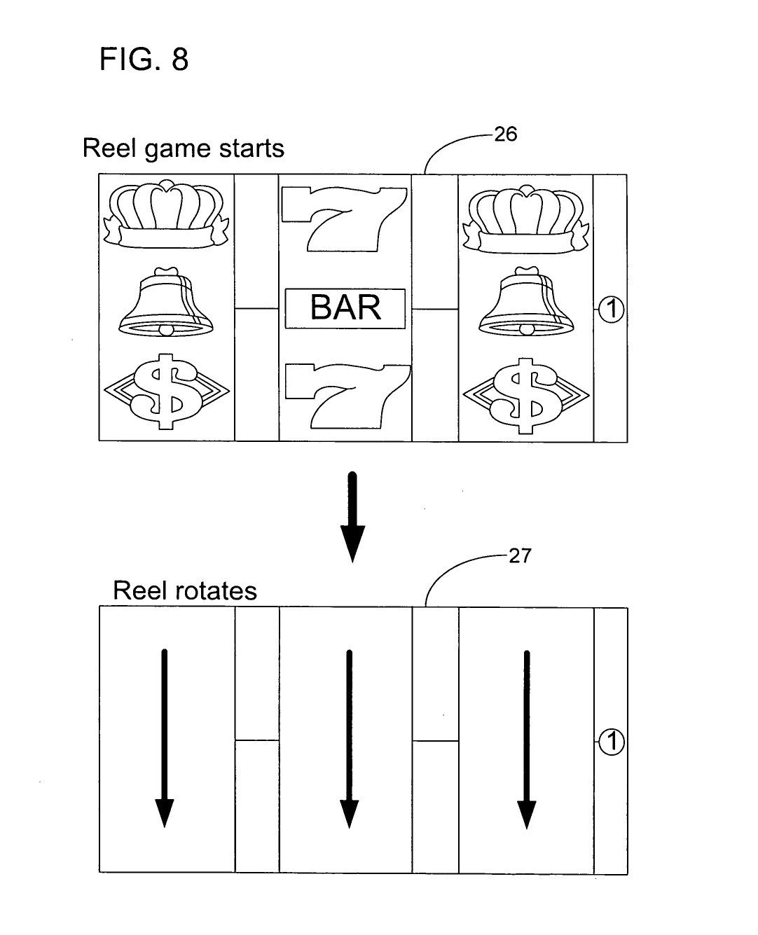

Next, an example of a game, which is executed by a gaming machine related to the present invention, will be explained. FIGS. 8-15 show a series of flows of an example of the game related to the present invention. FIG. 8 is a drawing illustrating an example of a game which is executed by a gaming machine related to the present invention. A display of a gaming machine is shown in FIG. 8. An upper row display 26 in FIG. 8 shows a state before a reel game is started. When a reel game is started, as shown in a lower row display 27 in FIG. 8, a reel will start rotation.

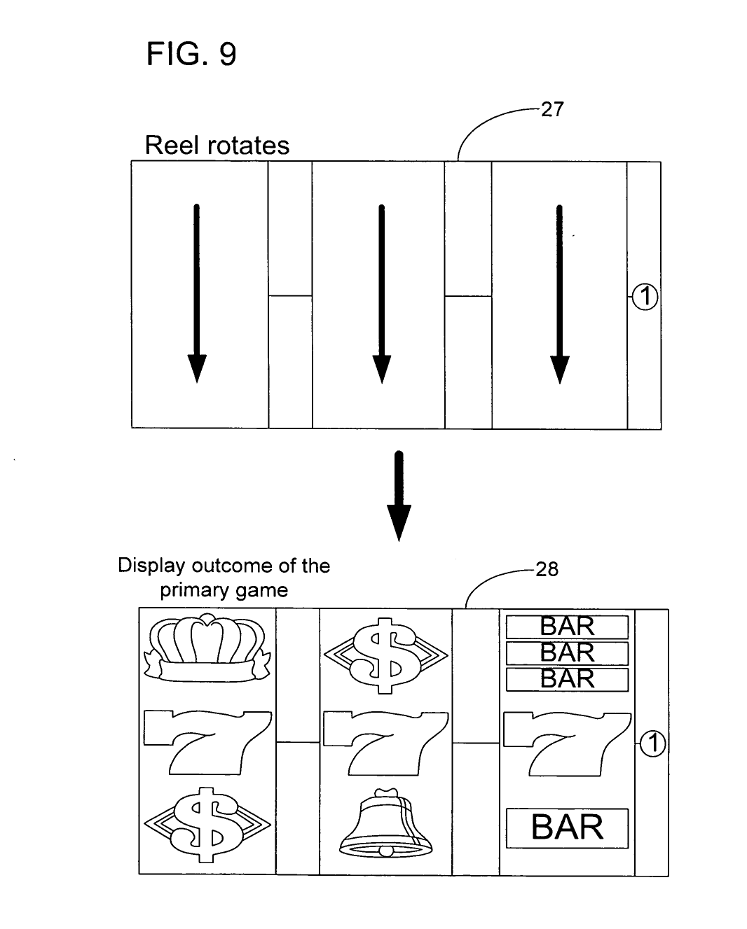

FIG. 9 is a drawing illustrating the state where a game status illustrated in FIG. 8 has advanced. A display of the gaming machine is illustrated in FIG. 9. An upper row display 27 in FIG. 9 shows the state where a reel is rotating. A lower row display 28 of in FIG. 9 shows the state where the reel is stopped after rotation and the result of the primary game is displayed. Three symbols “7” are located in a line on the middle of the display 28, and having won a prize by a lottery of primary game is shown. In this case, for example, a credit may be paid back to a player.

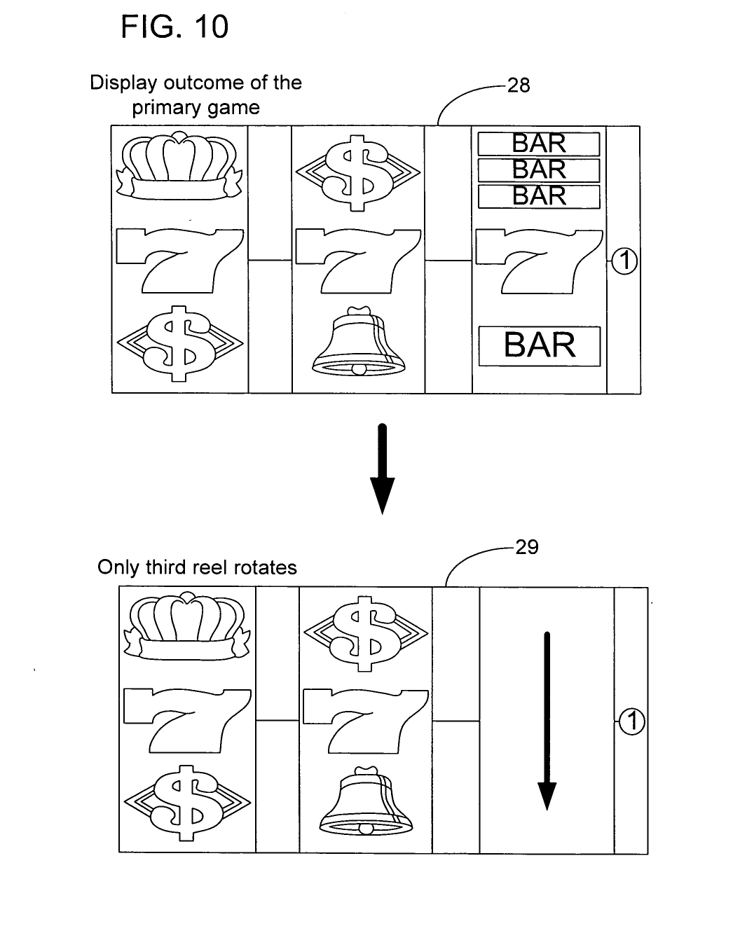

FIG. 10 is a drawing illustrating the state where a game status illustrated in FIG. 9 has advanced. A display of gaming machine is shown in FIG. 10. FIG. 10 shows a stage where only the third reel of the reel display rotates after displaying a winning-a-prize result of primary game, and an indication is started as a result of the tertiary game. Concretely, the upper row display 28 of in FIG. 10 shows a winning-a-prize result of primary game. The lower row display 29 of in FIG. 10 shows a stage where only the third reel of the reel display 29 is rotating in order to display a winning-a-prize result of the tertiary game.

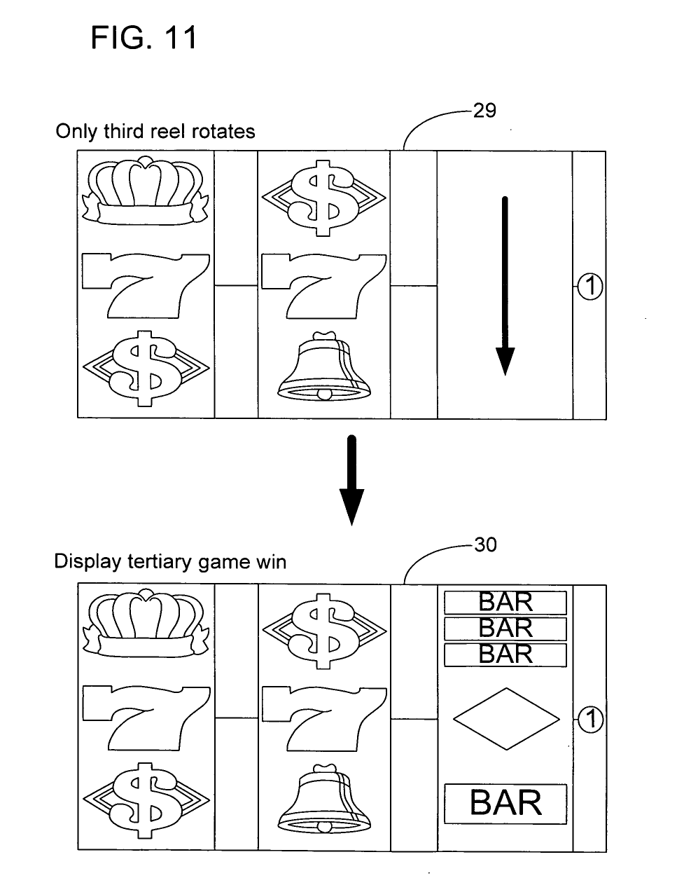

FIG. 11 is a drawing illustrating the state where a game status illustrated in FIG. 10 has advanced. A display of gaming machine is shown in FIG. 11. FIG. 11 shows the state where only the third reel of the reel display (an upper row display 29 in FIG. 11) displays a winning-a-prize result of the tertiary game after rotation (a lower row display 30 in FIG. 11). A symbol “7”, “7”, and “⋄” are displayed on the middle of a display 30, and having won a prize of the tertiary game is shown.

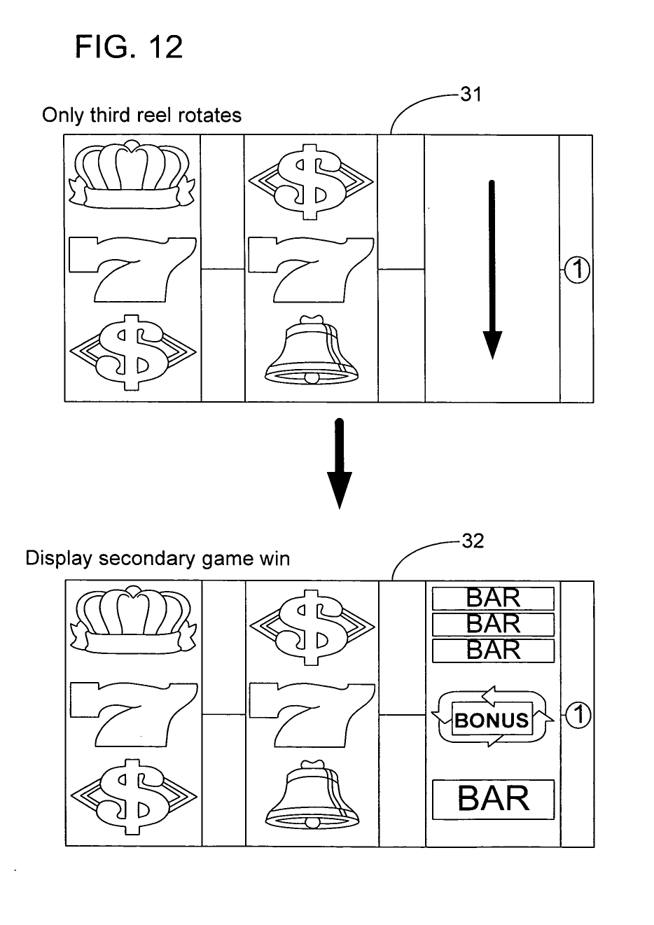

FIG. 12 is a drawing illustrating the state where a game status illustrated in FIG. 11 has advanced. A display of gaming machine is shown in FIG. 12. The upper row display 31 in FIG. 12 shows the state where only the third reel has started rotation after a winning-a-prize result indication of the tertiary game. And a lower row display 32 of a drawing shows the state where secondary game winning a prize is displayed. A symbol “7”, “7” and “Bonus” are displayed on the middle of display 32, which are the secondary game winning-a-prize result indications.

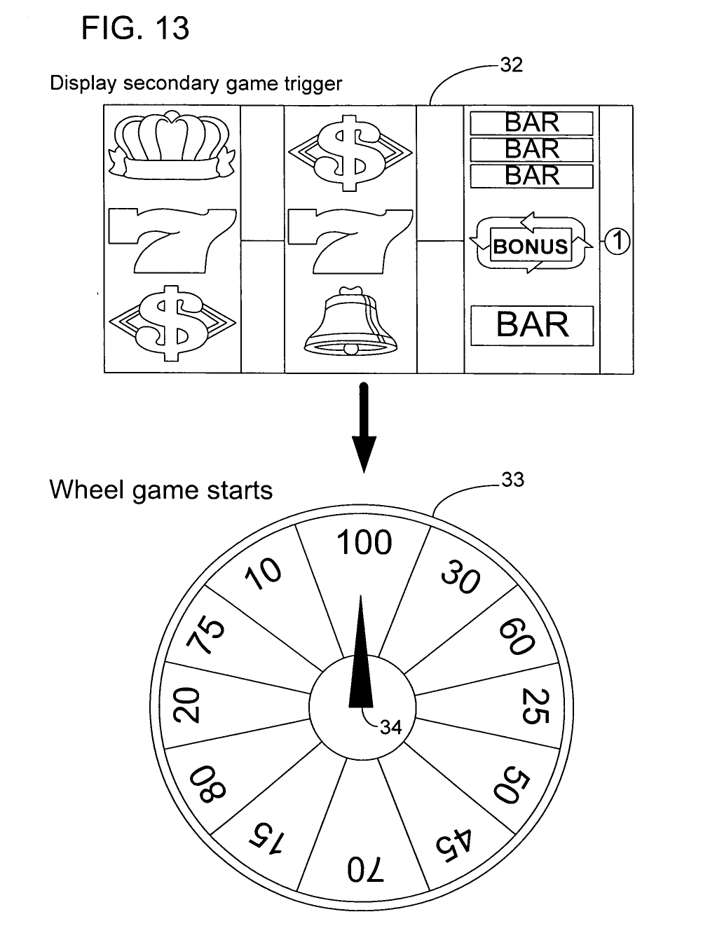

FIG. 13 is a drawing illustrating the state where a game status illustrated in FIG. 12 has advanced. The display 32 and a wheel 33, which show a secondary game winning-a-prize result, are shown in FIG. 13. A wheel game will be started when a prize is won by a lottery of the secondary game. A wheel is divided into a plurality of sections, and a number, which a player can get, is displayed on each section. In a wheel game, a wheel stops, after the wheel rotates, and a credit corresponding to the number which arrow 34 has pointed out is repaid to the player.

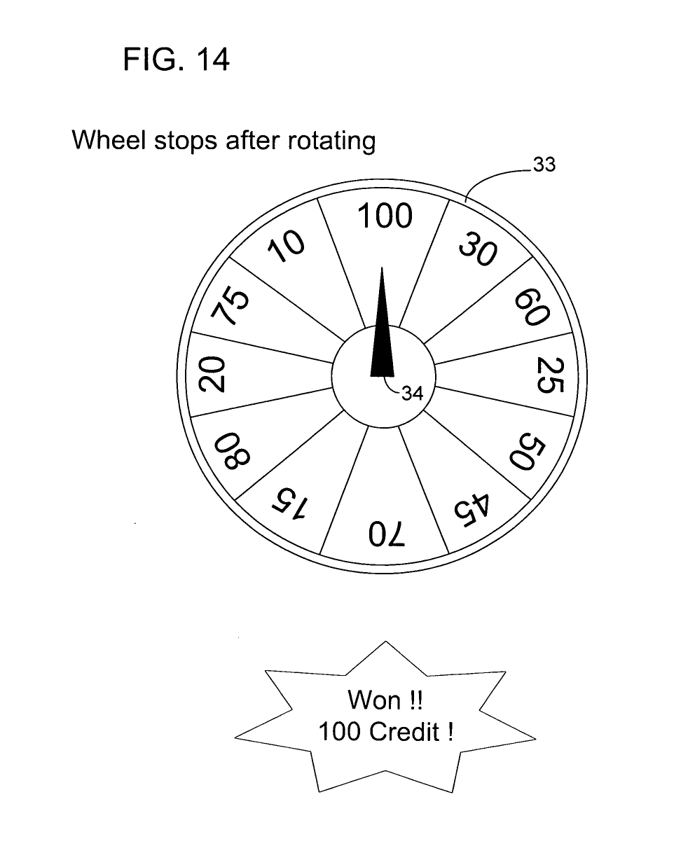

FIG. 14 is a drawing illustrating the state where a game status illustrated in FIG. 13 has advanced. FIG. 14 shows a wheel 33. FIG. 14 shows the state where a wheel rotated and stopped. The arrow 34 is pointing to a number “100” and refund of at least credits becomes final and conclusive against a player.

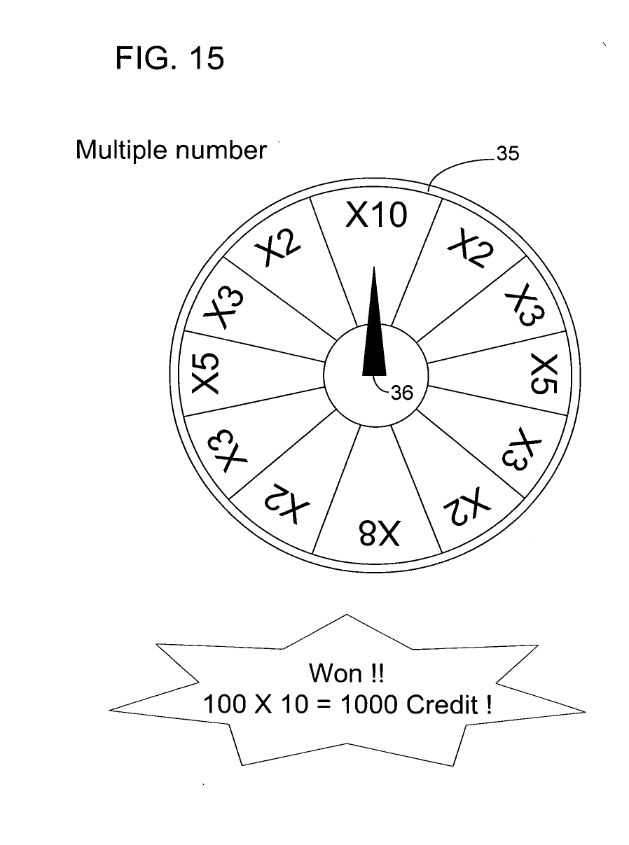

FIG. 15 is a drawing illustrating the state where a game status illustrated in FIG. 14 has advanced. FIG. 15 shows a wheel 35. When determination of the amount of the minimum credit repaid to a player in a form as explained in FIG. 14 is set, a wheel on which a plurality of magnifications displays as shown in FIG. 15 is displayed. Here, a game which determines the magnification of the already determined amount of the minimum credit is performed by using this wheel. For example, in FIG. 15, since arrow 36 shows magnification “×10”, the amount of a credit finally repaid against the player constitutes “1000” credits by “100×10”. Thus, a wheel game may be configured by two processes of determination of the amount of a credit, and determination of magnification by which the amount is multiplied.

As mentioned above, although the example of the game related to the present invention was explained, this game is not limited to this example. For example, when displaying a winning-a-prize result of the secondary game or the tertiary game, after only third reel rotates, when a symbol “7”, “7”, and “⋄” (⋄ emits blue lights) are displayed, it may mean that the tertiary game has been won, and on the other hand, when a symbol “7”, “7”, and “⋄” (⋄ emits red lights) are displayed, it may means that the secondary game has been won. When displaying a winning-a-prize result of the secondary game or the tertiary game, not only the third reel rotates but also any kind of display may be acceptable. For example, a winning-a-prize result may be displayed after only the first reel or the second reel other than the third reel rotate, and after all the reels rotate, it may be displayed.

The number of reels may be not three reels but five reels, and the reel may not be a matrix of 3×3, or may be matrices, such as 3×5 or 5×5. The winning-a-prize result indications may be not “7”, “7”, and “Bonus”, but any kind of indication may be acceptable. The game performed after the secondary game winning a prize does not need to be a wheel game, and may be a bingo game, a jack pot game or a game that can be chosen from among a plurality of subjects.

In a wheel game, it is not necessary to determine the amount of a credit and the magnification which multiplies to the amount of the credit. Only either one (a credit or magnification) may be determined. Or either may be chosen in a wheel game among a credit or elements, for example, a plurality of subjects (symbols etc.), other than magnification. The number of wheels does not need to be one and they may be a plurality wheels, (such as two or three wheels). The mark, which points each section on the wheel, does not need to be an arrow, and may be a ball, a diamond, etc. The number of marks, which points the section does not need to be one, and they may a plurality of marks, (such as two or three marks).

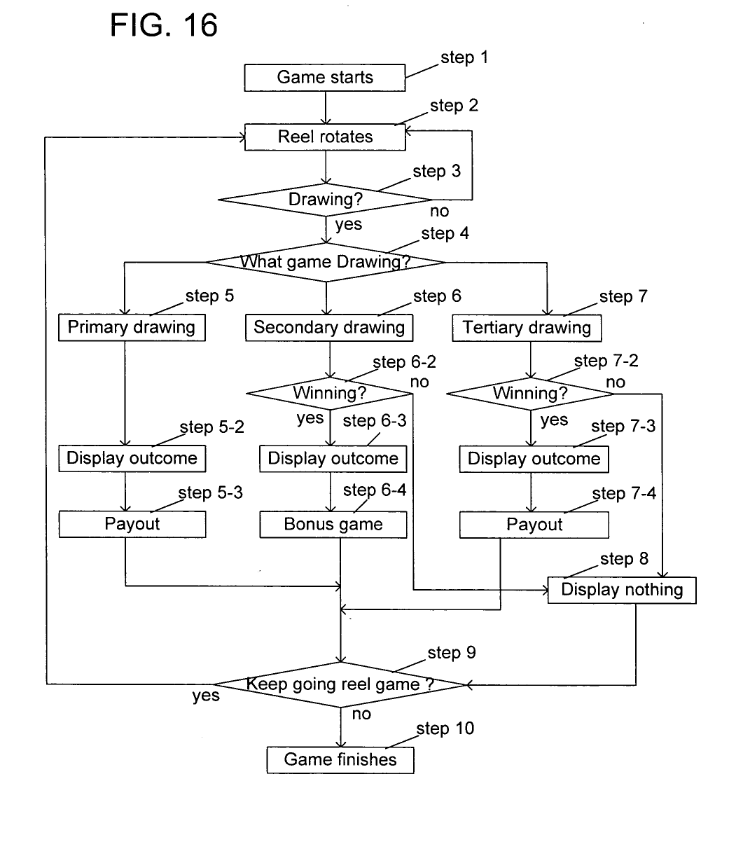

Next, the operation which is executed by a game machine related to the present invention will be described. FIG. 16 is a flow chart which illustrates an operation which is executed by the game machine related to the present invention. In this operation, a reel game starts first (step 1). When the game starts, a reel mounted in the game machine will rotate and the game will advance (step 2). It is determined whether a lottery for the winning a prize is performed in parallel to the advance of the reel game (step 3). In cases where it is determined that lot is cast, it is determined which lottery (game) of primary, secondary, or tertiary is performed (step 4). In cases where it is determined that lot is not cast, the reel game is continued without casting lots (step 2).

A primary lottery is performed in cases where it is judged that a primary lottery is performed (step 5). Regardless of the result of the winning a prize, the result will be displayed on the display (step 5-2). And refund is made in cases where it is winning a prize (step 5-3). On the other hand, in case where it is determined that a secondary lottery is performed, the secondary lottery is performed (step 6) and it is determined whether the result is winning a prize (step 6-2). In cases where a result of the secondary lottery is winning a prize, the result is displayed on the display (step 6-3), and in cases where it is not winning a prize, it is not displayed on the display (step 8). A bonus game will be executed when the winning-a-prize result of the secondary lottery is displayed on a display (step 6-4).

On the other hand, in cases where it is determined that a tertiary lottery is performed, the tertiary lottery is performed (step 7) and it is determined whether the result is winning a prize (step 7-2). In case where a result of the tertiary lottery is winning a prize, the result is displayed on the display (step 7-3), and in case where it is not winning a prize, it is not displayed on the display (step 8). When the winning-a-prize result of tertiary lottery is displayed on the display, refund to the player will be executed (step 7-4). Any one may be chosen and executed, or a plurality of lotteries may be chosen from these, such as, a lottery of primary, secondary, and tertiary may be executed. In case where a plurality of lotteries are executed, timing by which these lotteries are made may be the same, or may differ.

When the lottery game is executed and a bonus game and refund are executed, it will be determined whether it continues a reel game (step 9). When it is determined that it continues a reel game, a reel game will rotate again and will resume the game (step 2). The whole game will be completed when the reel game is determined to be an end (step 10).

The present invention is not limited to the above embodiment and various changes and modification may be made without departing from the scope of the invention.

What is claimed is:

1. A gaming machine comprising:
a wager device for receiving a wager;
an initiator for performing a primary game in response to the wager;
a processor for implementing a secondary game independently of the primary game;
a reel display for indicating outcome of the primary game and winning outcome of the secondary game on a reel; and
a payout device for awarding a reward according to the winning outcome of the secondary game,
wherein the initiator works independently of the processor.

2. A gaming machine of claim 1,
wherein the reel display indicates the winning outcome of the secondary game between the outcome of the primary game and an initiation of the primary game.

3. A gaming machine of claim 1,
wherein the processor further implements a tertiary game independently of the primary game and the reel display indicates winning outcome of the tertiary game.

4. A gaming machine of claim 3,
wherein the reward of the secondary game is bigger than a reward of the tertiary game.

5. A gaming machine of claim 3,
wherein the reel display indicates the outcome of the primary game in a first step, indicates the winning outcome of the tertiary game in a second step and indicates the winning outcome of secondary game in a third step, and the first step, the second step and the third step are continued.

6. A gaming machine of claim 1,
wherein the processor implements a special game after the reel display indicates the winning outcome of secondary game.

7. A gaming machine of claim 6,
wherein the special game is a roulette game or a wheel game.

8. A gaming machine comprising:
an initiator, which starts a primary game in response to receiving a wager;
a processor, which commences a secondary game independently of the primary game and decides when outcome of the secondary game is winning outcome;
a reel display, which represents a trigger information on a reel when the outcome of the secondary game is winning outcome; and
a controller, which;
a) communicates with the processor and the reel display,
b) receives signals from the processor, and
b) transmits signals to the reel display,
wherein the initiator works independently of the processor and the controller.

9. A gaming machine of claim 8,
wherein the processor further commences a tertiary game independently of the primary game and the reel display represents winning outcome of the tertiary game.

10. A gaming machine of claim 8,
wherein the reel is configured by a plurality of cells forming columns, and the reel display indicates a plurality of symbols in the cells, and the reel display indicates symbols in columns other than a predetermined column in a first step, and the reel display indicates symbols in the predetermined column in a second step.

11. A gaming machine of claim 10,
wherein the predetermined column is at a far right on the reel.

12. A gaming machine of claim 11,
wherein the trigger information and winning outcome of a tertiary game have the same shape of a symbol stopping at the column at far right on a reel and these symbols has a different color with each other.

13. A gaming machine of claim 8,
wherein the processor commences a special game after the reel display represents the trigger information.

14. A gaming machine of claim 13,
wherein the special game is a roulette game or a wheel game.

15. A gaming machine of claim 13,
wherein the special game includes a wheel representing a plurality of numbers and a wheel representing a plurality of magnification ratios.

16. A gaming system comprising:
a host computer; and
a plurality of gaming machines connected to the host computer, each of the gaming machines including;
an initiator, which commences a primary game in response to receiving a wager;
a processor, which implements a secondary game independently of the primary game;
a reel display, which represents outcome of the primary game and winning outcome of the secondary game on a reel; and
a controller, which;
a) communicates with the processor and the reel display,
b) receives signals from the processor, and
c) transmits signals to the reel display,
wherein the initiator works independently of the processor and the controller.

17. A gaming system of claim 16,
wherein the processor further implements a tertiary game independently of the primary game and the reel display represents winning outcome of the tertiary game.

18. A gaming system of claim 16,
wherein the reel display represents the winning outcome of the secondary game between the outcome of a primary game and an initiation of the primary game.

19. A gaming system of claim 17,
wherein a reward of the secondary game is bigger than a reward of the tertiary game.

20. A gaming machine of claim 16,
wherein the processor implements a special game after the reel display represents the winning outcome of the secondary game.

21. A gaming machine of claim 20,
wherein the special game is a roulette game or a wheel game.

22. A gaming machine of claim 20,
wherein the special game includes a wheel representing a plurality of numbers and a wheel representing a plurality of magnification ratios.
